(19) United States
(12) Patent Application Publication
(10) Pub. No.: US 2006/0284831 A1
(43) Pub. Date: Dec. 21, 2006

(54) Optical input device with a rotatable surface

(76) Inventor: Paul K. Rosenberg, Sunnyvale, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/158,157

(22) Filed: Jun. 21, 2005

(51) Int. Cl. G09G 5/00

(52) U.S. Cl. 345/156

(57) ABSTRACT

A input device comprises a navigation member, a light source, a sensor module, and a support structure. The navigation member includes a substantially spherical first portion and a second portion, the first portion extending outwardly from the second portion. The light source is configured to illuminate the first portion and the sensor module is configured to detect movement of the illuminated first portion to enable capture of user control inputs. The support structure includes a support surface configured to enable sliding rotational movement of the first portion relative to the sensor module in response to tilting movement of the second portion of the navigation member.

### BACKGROUND

A pointing device is typically used for controlling the position of a cursor or pointer on a display, such as a computer display. For desktop personal computers (PC's), a commonly used pointing device is the “mouse”. A mouse is a hand held object that is moved over a flat surface near the keyboard to control the motion of a cursor on the computer display. The direction and distance over which the mouse is moved determines the direction and distance the cursor moves on the display.

While the mouse has provided a satisfactory solution to the pointing device problem in the desktop PC market, a similarly successful device is not available for portable and hand-held computers, and other portable electronic devices. For portable electronic devices, such as laptop computers, cellular telephones, personal digital assistants (PDAs), digital cameras, portable game devices, pagers, portable music players (e.g., MP3 players), and other devices, it may be undesirable to use an external pointing device, such as a mechanical mouse or an optical mouse, coupled to the device. It is often inconvenient to carry around the additional equipment, and these portable electronic devices are often used in environments that lack a sufficiently large flat surface over which a mouse can be moved.

Currently, there are two dominant solutions to the pointing device problem in the laptop marketplace, which are the Synaptics capacitive TouchPad™ and the IBM TrackPoint™. Other companies make versions of these devices with similar functionality. The TrackPoint™ is a small button that is typically placed in the center of the laptop keyboard. The button may be moved in a manner analogous to a “joy stick” by applying a lateral force to the top of the button with a finger, and is commonly referred to as an isometric joystick or a pointing stick. These types of devices enable high-speed movements of a cursor or other screen-related objects, but with less precision than a mouse-type pointing device.

The TouchPad™ is a blank rectangular pad, typically 50-100 mm on a side, and typically placed in front of the keyboard of most laptops. The device senses the position of a finger on the surface of the rectangle relative to the edges of the device. These types of devices enable precise, fine movements that one would expect with a conventional mouse-type pointing device.

However, while Touch Pad™ type devices and pointing sticks, such as the TrackPoint™ device, enjoy some advantages over conventional optical pointing devices, they experience disadvantages in other ways. For example, some consumers do not like the feel or type of cursor control offered by pointing sticks or Touch Pad™ type devices. Moreover, with the increasing miniaturization and ever-changing morphology of portable electronics devices, the size, shape, and/or operating characteristics of the TouchPad™ type pointing devices and/or pointing sticks sometimes inhibit their use with smaller portable electronic devices.

Accordingly, manufacturers and designers of electronic devices still face challenges in reducing the size of pointing devices while adapting their functions to enhance the accuracy and effectiveness of those pointing devices.

### SUMMARY

Embodiments of the invention are directed to a control input device. In one embodiment, a control input device comprises a navigation member, a light source, a sensor module, and a support structure. The navigation member includes a substantially spherical first portion and a second portion, the first portion extending outwardly from the second portion. The light source is configured to illuminate the first portion and the sensor module is configured to detect movement of the illuminated first portion to generate movement information for a screen pointer. The support structure includes a support surface configured to enable sliding rotational movement of the first portion relative to the sensor module in response to tilting movement of the second portion of the navigation member.

### BRIEF DESCRIPTION OF THE DRAWINGS

FIG. 1 is block diagram illustrating an input device, according to an embodiment of the invention.

FIG. 2 is a flow diagram illustrating a method of navigation, according to an embodiment of the present invention.

FIG. 3 is a perspective view of an input device, according to an embodiment of the invention.

FIG. 4 is a diagram illustrating a cross-sectional view along section line 4-4 of the input device shown in FIG. 3 according to an embodiment of the present invention.

FIGS. 5A and 5B are diagrams illustrating an exploded view of the pointing device of FIG. 3, according to an embodiment of the present invention.

FIG. 6 is a diagram illustrating a top plan view of a portable electronic device, according to an embodiment of the present invention.

FIG. 7 is a block diagram illustrating an input device and host device, according to an embodiment of the present invention.

FIG. 8 is a diagram illustrating a navigation member of an input device, according to an embodiment of the present invention.

FIG. 9 is diagram illustrating a navigation member of an input device, according to an embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

Embodiments of the invention are directed to control input devices and/or portable electronic devices including control input devices. Control input devices, include but are not limited to, pointing devices. In particular, embodiments of the invention enable optically-based navigation via a tiltable navigation member that includes a first portion that is tiltable in response to an external force (e.g., a downward finger pressure) to cause slidable rotation of a second generally spherical portion. A light source illuminates the generally spherical portion of the navigation member so that slidable rotation of the illuminated generally spherical portion of the navigation member relative to a sensor module generates movement information for controlling a screen pointer (or other functions). A support structure of the pointing device constrains the navigation member from lateral movement relative to the sensor module while maintaining the generally spherical portion in sliding rotational contact with a generally spherical support surface of the support structure. With this arrangement, a user is able to cause substantial movement of a screen pointer by relatively minor tilting of a navigation member (with minimal lateral movement of their finger). The navigation member effectively converts a downward tilting motion of a disc-like portion into a rotational sliding motion of a curved or generally spherical portion that acts as a navigation surface. Employing a curved navigation surface enables the potential area of the illuminated navigation surface (that is sensed by the sensor module) to be substantially larger than the extent (e.g., distance) of lateral movement of the finger that causes the slidable rotation of the navigation surface.

In one embodiment, a control input device captures user control inputs based on a relative motion between the navigation member and a sensor wherein the user control inputs are associated with functions in addition to or instead of controlling a screen pointer. In one aspect, user control inputs relate to, but are not limited to, selecting or manipulating symbols visible on a display device, activating directional or speed inputs for video game controllers, for direct control of a mechanical or electrical system such as speed and turn inputs for controlling an automobile or toy vehicle, and menu navigation for portable electronic devices, such as mobile phones, portable audio devices, personal digital assistants, electronic cameras, etc.

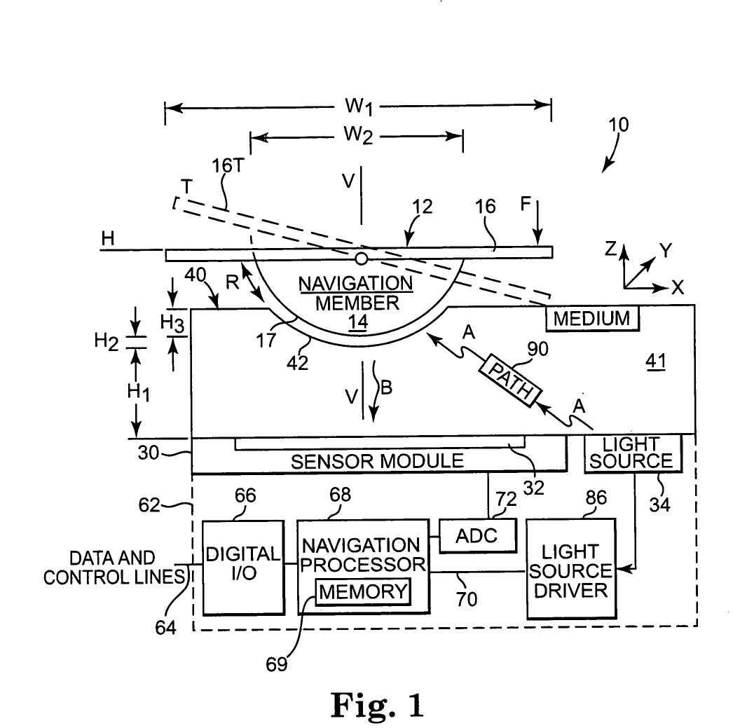

Examples of an input device, including but not limited to, a pointing device according to embodiments of the invention are described and illustrated in association with FIGS. 1-9.

FIG. 1 is a block diagram illustrating major components of a pointing device 10, according to one embodiment of the present invention. As shown in FIG. 1, pointing device 10 comprises navigation member 12 and navigation sensor module 30. Sensor module 30 comprises sensor array 32, as well as light source 34. In one embodiment, navigation member 12 comprises first portion 14 and second portion 16. In one aspect, first portion 14 comprises a generally spherical member defining a navigation surface 17 (e.g., a navigation sphere) and second portion 16 comprises a generally disc shaped member.

In one embodiment, optical pointing device 10 also comprises body 40 interposed between navigation member 12 and sensor module 30. Body 40 comprises an at least partially transparent or generally transparent medium 41 and includes a support surface 42 to enable sliding rotational movement of navigation surface 17 relative to support surface 42 through a generally arcuate field of motion. Together, navigation surface 17 and support surface 42 act as sliding mechanism with the pair acting as opposed surfaces sized and shaped for slidable rotation relative to each other.

In another aspect, support surface 42 is sized and shaped to prevent lateral translational movement of navigation member 12 relative to body 40, during the ongoing slidable rotation, which thereby maintains first portion 14 of navigation member 12 in general alignment with sensor array 32 along generally vertical axis V. In one aspect, support surface 42 comprises a recess formed in body 40 which has a depth (as indicated by H3) sufficient to prevent the lateral movement of navigation member 12. In another aspect, support surface 42 defines a generally spherical concave surface that is sized and shaped to generally reciprocate the size and shape of the generally convex spherical navigation surface 17 of navigation member 12.

As shown in FIG. 1, first portion 14 of navigation member 12 is configured for slidable rotational movement (as indicated by rotational direction arrow R), while also being maintained in a substantially the same vertical position relative to cradle surface of base surface (as indicated by height H2). In one aspect, height H2 is negligible as navigation surface 17 is in direct contact with support surface 42. In another aspect, height H2 is a minimal distance whereby navigation surface 17 is maintained in close proximity to but not in direct contact with support surface 42. In another aspect, height H1 represents a distance corresponding to a thickness of base 40 between support surface 42 and sensor array 32.

In one aspect, first portion 14 has a diameter (i.e., a width as seen in FIG. 1) of W2 while second portion 16 has a diameter (i.e., a width as seen in FIG. 1) of W1 that is generally larger than W2. In one aspect, diameter W1 of second portion 16 is substantially larger than diameter W2 of first portion 14 so that when an external force (F) is applied to second portion 16, this second portion 16 acts as a leveraging mechanism to cause sliding rotation of first portion 14.

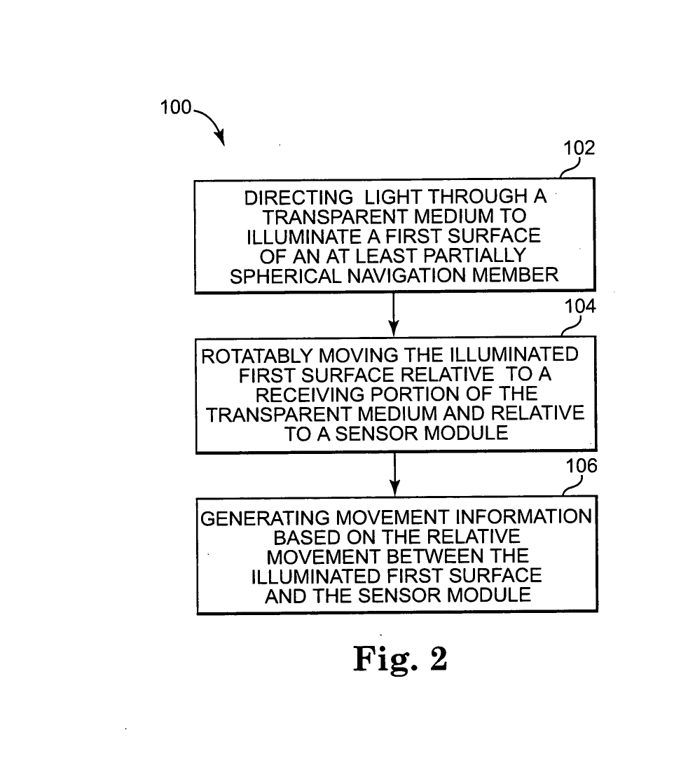

In one embodiment, the support structure further comprises a restraining mechanism (shown later) secured relative to the navigation member and relative to the base 40 to maintain navigation member 12 in position relative to base 40 while enabling selective tilting motion of the generally disc shaped portion of the navigation member. The tilting motion occurs between a generally horizontal at-rest position (as indicated by second portion 16 being generally parallel to plane H in FIG. 1) and a generally non-horizontal tilted position (as indicated by dashed lines 16T, and indicator T in FIG. 1). In one aspect, the restraining mechanism is a resilient member that is interposed between a portion of navigation member 12 and a portion of base 40. This embodiment is later described and illustrated in association with FIGS. 2-8.

In one embodiment, navigation surface 17 comprises an at least partially reflective or generally reflective surface that reflects light from light source 34 that is transmitted through body medium 41 to produce illuminated patterns suitable for detection at sensor array 32. In one aspect, navigation surface 17 comprises a distinctive opaque pattern, such as a contrast pattern. Additional aspects of patterns defining navigation surface 17 are described and illustrated in greater detail in association with FIGS. 8-9.

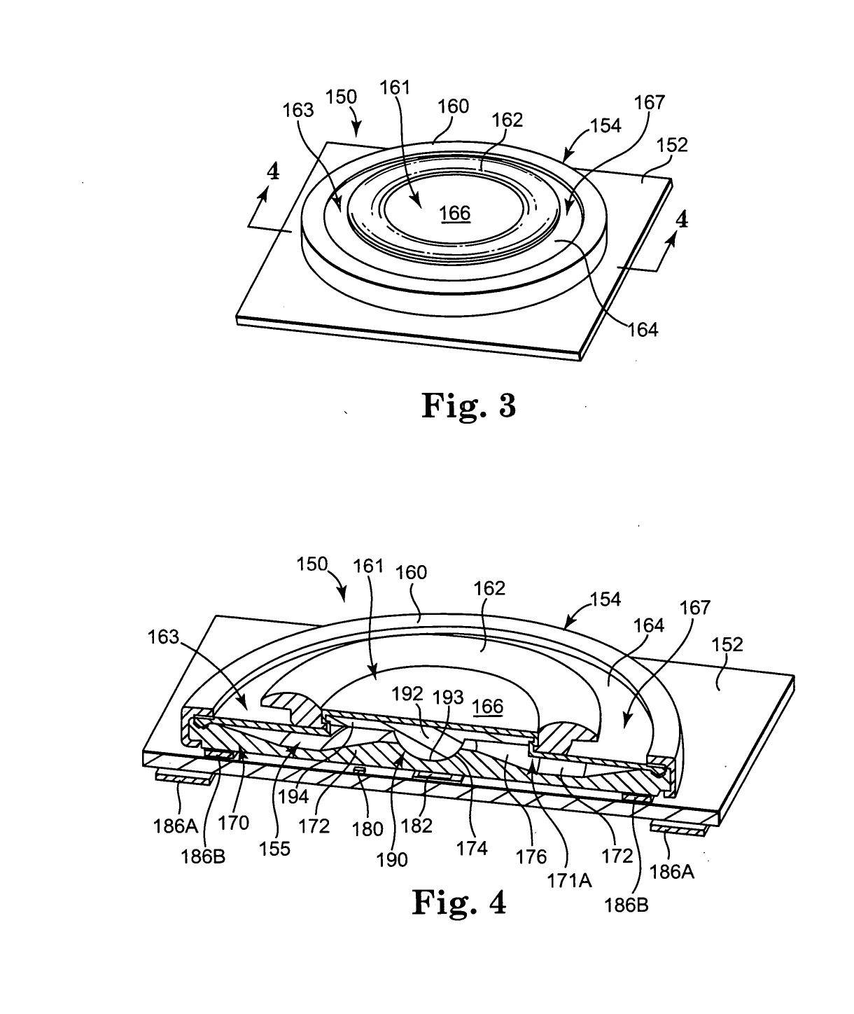

In one aspect, movement information generated via sensor array 32 based on navigation surface 17 is highly accurate because the features of this navigation surface, such as a contrast pattern, are known and relatively stable. In one embodiment, navigation surface 17 is generally excluded from dust, markings, etc. that otherwise can cause noise or bad pixels in digital images corresponding to the navigation surface. Accordingly, embodiments of the invention enable control over the type and quality of navigation surface as well as protection of the navigation surface based on its general exclusion from ambient conditions (external to pointing device 10), as will be further illustrated in association with FIGS. 3-4.

In one embodiment, sensor module 30 forms a portion of optical navigation sensor integrated circuit (IC) 60. As shown in FIG. 1, optical navigation sensor 60 includes digital input/output circuitry 66, navigation processor 68, analog to digital converter (ADC) 72, sensor array (or photoarray) 34 of sensor module 30, and light source driver circuit 86.

In operation, according to one embodiment, light source 34 emits light (A) through medium 41 of body 40 to illuminate navigation surface 17 and thereby produce reflected optical effects caused by a contrast pattern of navigation surface 17 or thereby produce reflected optical images representative of the features of navigation surface 17. In one embodiment, light source 34 is a light emitting diode (LED). In one embodiment, light source 34 is a coherent light source or an at least partially coherent light source. In one embodiment, light source 34 is a laser. In one form of the invention, light source 24 is a vertical cavity surface emitting laser (VCSEL) diode. In another form of the invention, light source 34 is an edge emitting laser diode. Light source 34 is controlled by driver circuit 86, which is controlled by navigation processor 68 via control line 70. In one embodiment, control line 70 is used by navigation processor 68 to cause driver circuit 86 to be powered on and off, and correspondingly cause light source 34 to be powered on and off.

In one embodiment, a light path 90 is embodied within or near medium 41 to direct light from light source 34 to navigation surface 17 of navigation member 12. In one aspect, light path 90 comprises a light pipe or other directional reflective mechanism(s), such as total internal reflectance (TIR) mirrors, to direct light A to navigation surface 17.

Optical effects reflected from navigation surface 17, in response to illumination from light source 34, are received at sensor array 32 (e.g., a photoarray). In one embodiment, each photodetector in sensor array 32 provides a signal that varies in magnitude based upon the intensity of light incident on the photodetector. The signals from photo array 32 are output to analog to digital converter (ADC) 72, which converts the signals into digital values of a suitable resolution (e.g., eight bits). The digital values represent a digital image or digital representation of the illuminated portion of navigation surface 17. The digital values generated by analog to digital converter (ADC) 72 are output to navigation processor 68. The digital values received by navigation processor 68 are stored as frames within memory 69.

In one embodiment, navigation surface 17 defines a contrast pattern having varying spatial features that enable monitoring changes in a speed or direction of movement of navigation surface 17, which when processed via navigation processor 68, correspond to user control inputs associated with the movement of navigation member 14. In this embodiment, the navigation processor 68 does not attempt to construct an image of navigation surface 17 from optical effects received at sensor array 32 but rather produces a digital representation of those optical effects and then compares how the features associated with the contrast pattern that vary over time via the optical effects as the illuminated navigation surface 17 is moved relative to sensor array 32.

The overall size of sensor array 32 is preferably large enough to receive optical effects corresponding to several spatial features (or contrast pattern features). These optical effects or images of such spatial features produce translated patterns of pixel information as navigation surface 17 is moved relative to sensor array 32. The number of photodetectors in sensor array 32 and the frame rate at which their contents are captured and digitized cooperate to influence how fast navigation surface 17 can be moved relative to sensor array 32 and still be tracked. Tracking is accomplished by navigation processor 68 by comparing a newly captured sample frame with a previously captured reference frame to ascertain the direction and amount of movement, or by continually comparing optical effects associated with the contrast pattern of navigation surface 17 to ascertain the direction and amount of movement.

In another embodiment, using images generated via a lens and illumination source in a manner known to those skilled in the art, navigation processor 68 compares images of navigation surface 17 over time. In one aspect, navigation processor 68 performs a cross-correlation of sequential frames to determine motion information. In other embodiments, other correlation algorithms known to those skilled in the art are used to generate movement information based on a plurality of images received at sensor module 30 of pointing device 10.

Various functions performed by sensor module 30 and navigation sensor circuit 60 (FIG. 1) may be implemented in hardware, software, firmware, or any combination thereof. The implementation may be via a microprocessor, programmable logic device, or state machine. Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory (ROM), and random access memory.

FIG. 2 illustrates a method 100 of optical navigation using a pointing device, according to an embodiment of the invention. As shown in FIG. 2, at 102, a path of light is directed from a light source through a generally transparent medium to illuminate an at least partially spherical navigation surface. In one aspect, the light source and/or the medium comprises a light path, such as a light pipe, for guiding light to the navigation surface.

At 104, the illuminated navigation surface is slidably and rotatably moved relative to a receiving portion of the transparent medium and relative to the sensor module. In one aspect, the navigation surface defines a generally spherical portion of a navigation member (e.g., a navigation sphere) that protrudes outwardly from a generally disc shaped portion of the navigation member. Slidable rotation of the generally spherical portion is caused by tilting movement of the generally disc shaped portion in response to an external force applied to the generally disc shaped portion. In one aspect, the navigation surface is in substantially direct contact with the receiving portion of the transparent medium. In another aspect, at least a portion of the generally spherical portion of the navigation member is spaced from the receiving portion of the transparent medium.

At 106, movement information is generated based on the relative movement between the navigation surface and the sensor module. In one aspect, optical effects, which correspond to the illuminated navigation surface, received at the sensor module change over time as the navigation surface is rotated, and are compared to enable capturing user control inputs associated with the relative movement between the navigation member and the sensor module. In one aspect, the varying optical effects based on manipulations of the navigation member generate movement information for a screen pointer. In other aspects, these varying optical effects represent other control inputs (associated with manipulations of the navigation member) such as menu navigation, volume controls, mechanical or electrical systems parameter selection, etc., as previously identified.

In one embodiment, method 100 is performed using pointing device 10 as previously described and illustrated in association with FIG. 1, and as well as any one of pointing devices 150, 300, 350, as will be described in association with FIGS. 3-8.

FIG. 3 is a perspective view illustrating a pointing device 150, according to an embodiment of the invention. In one embodiment, pointing device 150 comprises substantially the same features and attributes as pointing device 10, as previously described in association with FIG. 1, as well as additional features described and illustrated in association with FIGS. 3-5B.

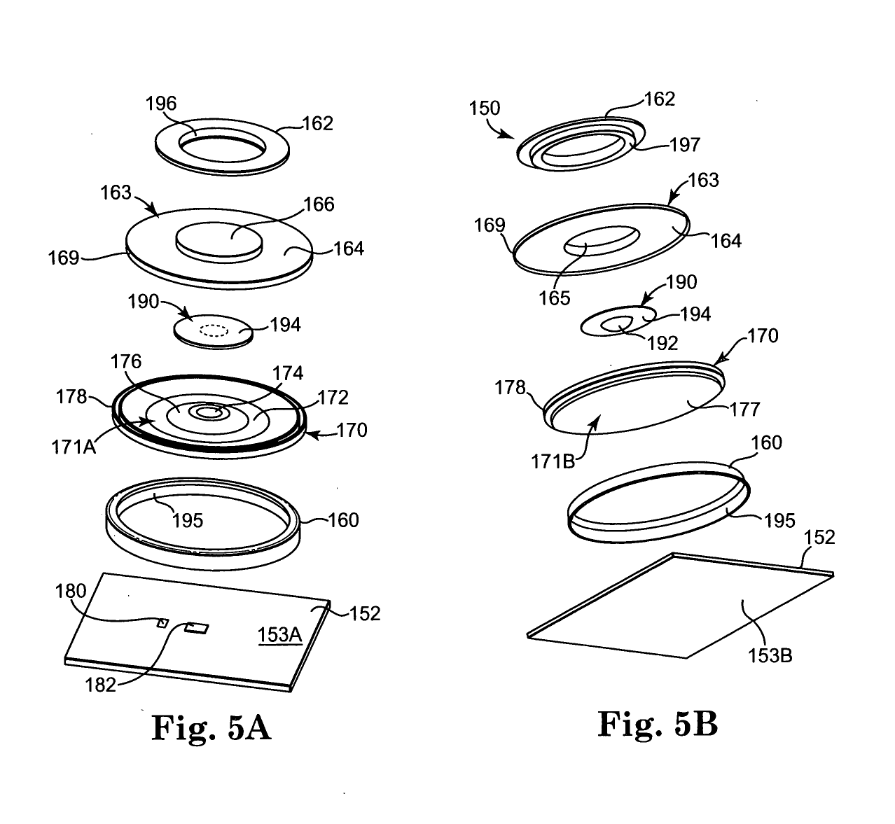

As shown in FIG. 3, pointing device 150 comprises substrate 152 and navigation mechanism 154. Navigation mechanism 154 comprises, among other things, outer ring member 160, inner ring member 162, and membrane 163 which includes outer portion 164 and inner portion 166. In one aspect, inner ring member 162 and inner portion 166 of membrane 163 together, along with a navigation member 190 (shown in FIGS. 4-5B) form a tilting disc 161.

In another aspect, outer ring member 160 and outer portion 164 of membrane 163 together form support structure 167, which enables limited tilting of finger unit 161 relative to outer ring member 160. In one aspect, support structure 167 comprises additional components or other components as further described in association with FIGS. 4A-9.

In one embodiment, membrane 163 comprises an elastomeric member that stretches to enable tilting of tilting disc 161 while also biasing the tilting disc 161 to return to a centered, generally level position as shown in FIG. 3. In one aspect, tilting disc 161 is sized and shaped to receive a finger tip to facilitate application of an external force to cause tilting of tilting disc 161. Tilting of tilting disc 161 in a particular direction and a particular speed, causes a corresponding direction and speed of movement in a cursor or screen pointer, as described in greater detail in association with FIGS. 4-9, or capture of a different user control input.

FIG. 4 is a sectional view of FIG. 3, as taken along lines 4-4, according to an embodiment of the invention. As shown in FIG. 4, pointing device 150 comprises the features and attributes illustrated in FIG. 3, and further illustrates additional aspects of pointing device 150. FIGS. 5A-5B are exploded views of FIG. 3, also further illustrating pointing device 150.

As shown in FIG. 4, pointing device 150 further comprises base 170, navigation member 190, light source 180, and sensor module 182. In one aspect, base 170 further defines support structure 167 while navigation member 190 further defines tilting disc 161.

As shown in FIGS. 4-5A, navigation member 190 include first portion 192 and second portion 194. In one embodiment, first portion 192 protrudes generally outward from a central region of second portion 194. In one aspect, second portion 194 comprises a generally disc-shaped member while first portion 192 comprises a generally spherically shaped member. In another aspect, the generally disc-shaped member comprises a generally flat member.

In one aspect, generally disc shaped second portion 194 has width (W1 as shown in FIG. 1) that is substantially greater than a width (W2 as shown in FIG. 1) of generally spherical first portion 192. This relationship provides a leverage mechanism to apply an external force (F) at a position (such as an outer region of general disc shaped portion 194) that is generally laterally outward from and spaced relative to the spherical surface. Moreover, since second portion 194 of navigation member 190 is generally flat, very little space is used to apply this external force.

In one embodiment, as shown in FIGS. 4-5B, the generally spherically shaped member first portion 192 is a generally convex member and a support surface (e.g., inner recess portion 174) of support structure 167 is a generally concave member that is sized and shaped to reciprocally receive the first portion 192. However, in another embodiment, first portion 192 of navigation member 190 is a generally concave, generally spherical member and a support surface (e.g., inner recess portion 174) of support structure 167 is a generally convex, generally spherical member.

As shown in FIG. 4-5B, in one embodiment, support structure 167 comprises base 170, outer portion 164 of membrane 163, and/or outer ring member 160. In another embodiment, support structure 167 additionally comprises substrate 152, which supports base 170 and outer ring member 160. In some embodiments, support structure 167 additionally comprises inner ring member 162 that helps secure navigation member 190 relative to membrane 163, as described further in association with FIGS. 5A-5B.

Base 170 comprises outer recess portion 172, inner recess portion 174, and ridge 176 interposed between outer recess portion 172 and inner recess portion 174. In one aspect, base 170 comprises a generally disc shaped member including one or more topographic features (e.g., ridge 176, recess portions 172 and 174) on a top surface 171A of base 170.

In one aspect, outer recess portion 172 and ridge 176 each have a generally annular shape, being arranged concentrically relative to each other as shown in FIG. 4, with inner recess portion 174 being arranged within the opening defined by annular ridge 176. In one aspect, inner recess portion 174 comprises a generally spherical surface, such as a generally concave hemispherical shape, that is sized and shaped to receive first portion 192 of navigation member 190 for slidable rotation of first portion 192 of navigation member 190 within and relative to inner recess portion 174 of base 170. In this arrangement, first portion 192 is slidably rotatable through a substantially hemispherical range of motion relative to inner recess portion 174. In other words, first portion 192 slidably rotates relative to inner recess portion 174 along or through one or more of three generally perpendicular axes that define the generally hemispherical shape of first portion 192 of navigation member 190 and/or of inner recess portion 174 of base 170. In one aspect, substantially the entire first portion 192 of navigation member 190 is in slidable contact with the support surface defined by inner recess portion 174. In addition, in another aspect, inner recess portion 174 has a depth, width, and shape that prevents lateral translation (side-to-side movement) of navigation member 190 relative to base 170 and the remaining portions of support structure 167.

In one embodiment, navigation member 190 in combination with inner ring member 162 and inner portion 166 of membrane 163 form tilting disc 161. Tilting movement of navigation member 190 relative to support structure 167 causes slidable rotation of illuminated first portion 192 of navigation member 190 relative to sensor module 180, thereby enabling generation of movement information for directing a screen pointer based on changes in optical signals at sensor module 182 (caused by differing optical effects from movement of first portion 192 of navigation member 190).

In one embodiment, light source 180 comprises a light emitting diode (LED). In another embodiment, membrane 163 is at least partially transparent and light source 180 produces a quantity of light that illuminates base 170 and membrane 163 to give the visual appearance of pointing device 150 being lighted. In other words, membrane 163 is backlit by light source 180 to provide a lighted pointing device 150.

In another embodiment, light source 180 comprises light originating from a light emitting diode (or other light generator) within a host (e.g., a phone, personal digital assistant, etc.) of the pointing device 150 that is conveyed to substrate 150 via a light pipe (or other light conveying mechanisms) to illuminate navigation surface 193 of navigation member 190. In one aspect, the light emitting diode (or other light generator) in the host is primarily used for other purposes, such as backlighting a keypad. Accordingly, this aspect of pointing device 150 is able to use a light generator already available in a host to provide light source 180. In other words, pointing device 150 need not have its own independent light source.

To assemble pointing device 150, generally disc shaped second portion 194 of navigation member 190 is inserted into recess portion 165 of membrane 163, which in turn is slidably inserted to be snap fit into inner ring portion 162 to retain membrane 163 and second portion 194 of navigation member 190 within inner ring member 162. In this arrangement, membrane 163 is captured between disc portion 194 of navigation member 190 and inner ring member 162 of support structure 167. In one aspect, membrane 163 is pre-shaped with recess portion 165 (FIG. 5B) while in another aspect, membrane 163 has a generally flat shape (i.e., lacking recess portion 165) prior to assembly with navigation member 190 and inner ring member 162.

This sub-assembly of navigation member 190, inner ring member 162 and membrane 163 is then placed onto base 170 (which is secured relative to substrate 152) with spherical navigation surface 194 of navigation member 190 removably inserted into inner recess portion 174 of base 170. In one aspect, inner ring member 162 is sized with a diameter to position inner ring member 162 directly over outer recess portion 172. Outer ring member 160 is then snap-fit or friction fit over the sub-assembly to secure an outer portion 166 of membrane 163 and base 170 relative to each other (within shoulder 195 of outer ring member 162), and relative to navigation member 190.

In one aspect, as shown in FIG. 4, outer portion 164 of membrane 163, outer ring member 162, generally disc-shaped portion 194 of navigation member 190, and upper surface 171A of base 170 define an interior chamber 155 that generally excludes ambient light and particle (dust, dirt) contamination from affecting navigation surface 193 on generally spherical portion 194 of navigation member 190.

In another aspect, as shown in FIG. 4, an outer edge 169 of membrane 163 becomes secured relative to outer ring member 160 and an outer edge 178 of base 170, which in turn maintains tension on outer portion 164 of membrane 163 between inner ring member 162 and outer ring member 160. In addition, because navigation member 190 is fixed within inner ring member 162 and inner portion 165 of membrane 163, and because base 170 is secured relative to outer ring member 160, membrane 163 acts under tension to hold (i.e., vertically constrain) first portion 192 of navigation member 190 within inner recess portion 174 of base 170. However, membrane 163 has enough elasticity so that when an external force (F) is applied to tilting disc 161 (specifically to second portion 194 of navigation member 190), membrane 163 enables navigation member 190 to tilt into a non-horizontal position (like position T in FIG. 1), causing first portion 192 to slidably rotate within inner recess portion 174 of base 170. Membrane 163 also is resilient so that after release of the external force, membrane 163 returns to its original shape, causing navigation member 190 to return to a non-tilted position (such as generally parallel to plane H in FIG. 1) and first portion 194 of navigation member 190 to return to a starting or center position within inner recess portion 174 of base 170.

In this arrangement, navigation member 190 in turn provides vertical support to membrane 163 to maintain outer portion 164 of membrane in a vertically spaced, and generally parallel relationship, relative to base 170. In one aspect, outer edge 178 of base 170 is sized and shaped so that when coupled with an outer edge 169 of membrane 163, this arrangement maintains vertical spacing of portion 166 of membrane 163 relative to upper surface 171A of base 170. This relationship also maintains a range of travel motion for inner ring member 162 (as connected to membrane 163 and navigation member 190) from its resting position (shown in FIG. 4) down into outer recess portion 172 of base 170 and back to its resting position.

Pointing device 150 enables manipulation of a navigation member via pressure applied with a fingertip without requiring a rolling action of the surface that the finger contacts. In other words, pointing device 150 enables a finger pressure to be applied to a non-rolling contact surface with the navigation member translating that finger pressure into a slidable rotation of an illuminated navigation surface, which is detected by a sensor module for capturing user control inputs, such as for controlling movement of a screen pointer or other selectable functions distinct from mere control of a screen pointer.

Moreover, in this arrangement, a generally downward vertical force (e.g., F in FIG. 1) is applied to the navigation member to cause relative movement between an navigation surface and a sensor module, which is unlike conventional pointing devices (e.g., a joystick) which use a generally lateral, horizontal force applied to cause relative movement between a navigation surface and a sensor. However, a pointing device of the embodiments of the invention also enables generally horizontal translations of the external force (applied via a fingertip) by sliding of fingertip laterally across navigation member or simply “rocking” navigation member in one direction or another.

In addition, the generally circular shape of the generally disc shaped portion 194 of navigation member 190 enables unidirectional (e.g., 360 degree) selection of a direction of movement by tilting the tilting disc 161 in virtually any direction to direct a corresponding movement of a screen pointer or to capture a user control input expressed via manipulation of generally spherical navigation portion 194 of navigation member 190.

The range of motion of tilting disc 161 is limited or determined by numerous parameters, depending upon relative size, shape, and position of components identified. For example, these parameters affecting the range of motion include, but are not limited to, one or more of: (1) the elasticity of membrane 163; (2) a distance of vertical spacing between second portion 194 of navigation member 190 and ridge 176 of base 170; (4) a distance of ridge 176 from inner recess portion 174 of base 170; and (5) a depth of outer recess portion 172 of base 170.

When the user applies a vertical force to navigation member 190 that is greater than a predetermined threshold, any change in the position of navigation member 190 on navigation surface (e.g., inner recess portion 174 of base 170) is reported to a host apparatus of which pointing device 150 forms a part. This change in position is used to move a cursor on a display of the host apparatus by a magnitude and a direction that depend on the magnitude and direction of the motion of navigation surface 194 while the vertical force was applied to navigation surface 194.

Accordingly, when the user releases navigation member 190 by removing the user's finger, navigation member 190 is returned to its centered position by a re-centering mechanism (e.g., membrane 163) that returns the navigation member 190 to the at-rest arcuate field of motion R (FIG. 1). Since the user's finger is not applying a vertical force to navigation member 190 during its return, the change in position associated with that return motion is not reported to the host device. That is, the cursor remains at its current location. This provides a convenient “re-centering” capability, typically achieved on a mouse by lifting and replacing the mouse at the center of the field of motion. Re-centering is particularly important in laptop computers, hand-held devices and other miniature applications in which the field of motion is constrained.

In one embodiment of the present invention, at least one pressure sensor or switch 186A positioned in, on, or near pointing device 150 determines two predetermined pressure levels. The first level is used to actuate the tracking of the cursor on the display as described above. The second level is used to implement the “click” function associated with a conventional mouse. Hence, the user can click at the current position of the cursor by increasing the pressure applied to navigation member 190. A mechanical click can also be implemented to provide tactile feedback for the “click” threshold. The at least one pressure switch is implemented as a single device or an array of devices.

In another embodiment, at least one pressure sensor 186B is deployed instead of pressure sensor 186A. As shown in FIG. 4, in one aspect, pressure sensor 186B is interposed generally between base 170 and substrate 150. In another aspect, pressure sensor 186B is located further laterally outward than shown in FIG. 4 with the pressure sensor (switch) 186B interposed between outer ring member 160 and substrate 152.

Another embodiment of a pressure senor (or switch) for providing a pressure activation function and a click function is described in association with FIG. 8.

In another embodiment, one or more components of pointing device 150, such as membrane 163 and/or outer ring member 160 (or other exposed parts), comprise an electrically conductive component or material to provide a low impedance path to ground for pointing device 150 in order to protect against introduction of an electrostatic discharge (ESD) into the circuitry associated with pointing device 150.

In another embodiment, navigation member 190 includes components having alternate shapes. For example, second portion 194 of navigation member 190 is not strictly limited to a generally disc shaped member (e.g., having a generally circular shape when seen in a top plan view). Accordingly, in one aspect, second portion 194 of navigation member 190 comprises a generally rectangular shaped member (e.g., when seen in a top plan view), generally polygonal shaped member (e.g., octagonal, hexagonal, etc.), or other shaped member that extends outwardly relative to the first portion 192 of navigation member 190 for providing a tilting function and for structural engagement with support structure 167 (e.g., membrane 163, inner ring member 162, etc.). In another aspect, base 170 is not strictly limited to a generally disc shaped portion (e.g., having a generally circular shape when seen in a top plan view) and comprises a generally rectangular shaped member (when seen in a top plan view), polygonal shaped member, or other suitable shape for supporting and constraining navigation member 190 relative to a base 170 via a support structure 167 in a manner substantially the same as previously described in association with FIGS. 1-5A.

In another embodiment, the previously described sub-assembly of navigation member 190, inner ring member 162, membrane 163 and base 170 is not secured directly to its own substrate 152 but is secured to a printed circuit board of a host electronic device (e.g., a mobile phone) which acts as substrate 152. In one aspect of this embodiment, the printed circuit board comprises light source 180 and sensor 182. Accordingly, the pointing device 150 need not supply its own light source 180 and/or sensor 182 but relies on and interfaces with light source 180 and/or sensor 182 as provided by a printed circuit board (or substrate) of a host device to which the pointing device 150 is mounted or in which the pointing device is incorporated.

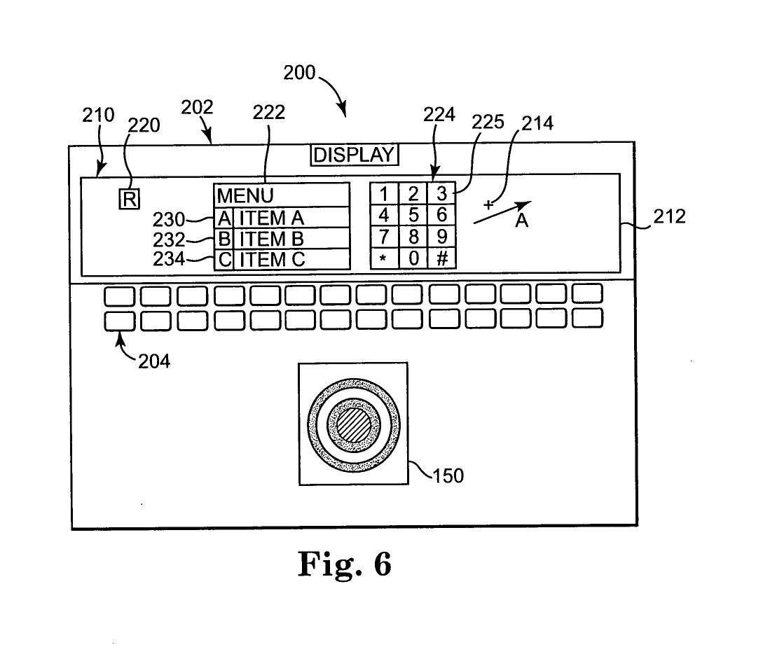

FIG. 6 is a diagram illustrating a portable electronic device 200 incorporating a pointing device 150, according to an embodiment of the invention. Pointing device 150 comprises substantially the same features and attributes as previously described in association with FIGS. 1-5 and 7-9. As shown in FIG. 6, device 200 comprises pointing device 150, display 202, and keyboard 204. Display 202 comprises screen 210 including cursor 214. Display 202 further comprises one or more elements of a graphical user interface (GUI) including, but not limited to icon 220, menu 222, and keypad 204. Menu 222 comprises first item 230, second item 232, and third item 234 arranged in a list. Keypad 224 comprises one or more activatable keys 225 representing numbers, letters, or other symbols. Operation of pointing device 150, as described in association with FIGS. 1-5B and 7-9, causes movement of cursor 214, highlighting of items 230-234 of menu 222, and/or highlighting/selection of items 225 of keypad 204, as well as capture of other user control inputs.

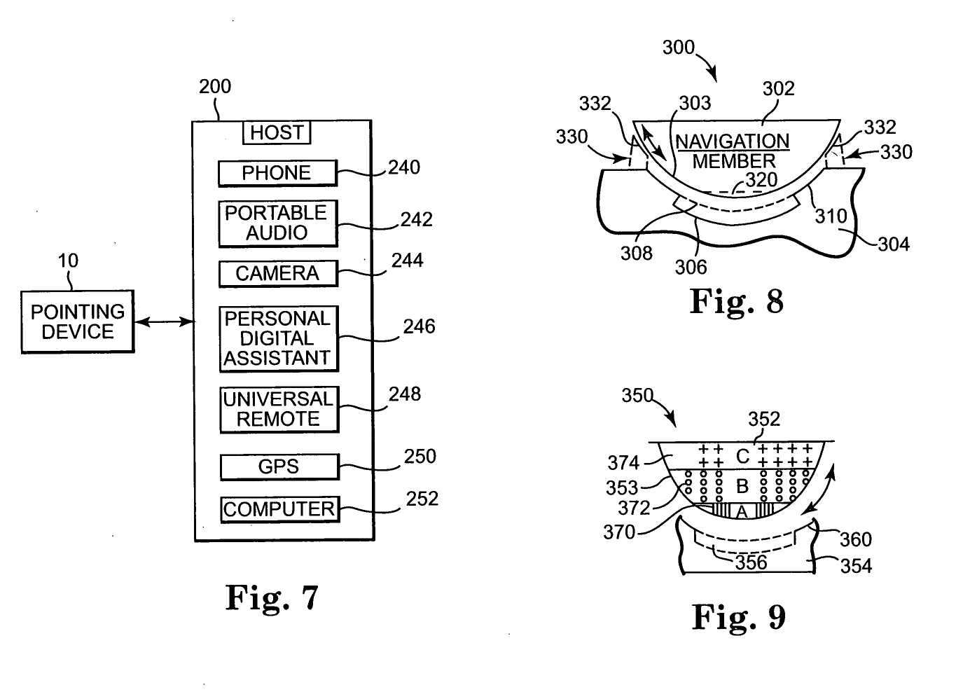

FIG. 7 is a block diagram of a pointing device and a host apparatus, which are in communication with each other. In one embodiment, host apparatus 200 comprises wireless phone 240, portable audio device 242, camera 244, personal digital assistant 246, universal remote 248, global positioning device 250, and computer 252. In one aspect, computer 252 is a portable computer while in another aspect, computer 252 is a desktop or stationary computer workstation.

FIG. 8 is a diagram illustrating a partial view of a pointing device 300, according to an embodiment of the invention. As shown in FIG. 8, pointing device 300 comprises navigation member 302 and support structure 304. Navigation member 302 comprises first generally spherical surface 303. Support structure 304 comprises first generally spherical support surface 310, that has a generally concave shape, to reciprocate the generally convex first surface 303 of navigation member 302. In one embodiment, pointing device 300 further comprises guiding mechanism 330 while other embodiments, pointing device 300 omits guiding mechanism 330.

In one embodiment, first surface 303 of navigation member 302 comprises recess portion 320 wherein first surface 303 is slidably movable relative to, and in contact against, support surface 310, except for recess portion 320 which does not contact support surface 310. Recess portion 320 defines a navigation surface that is configured for reflecting light from a light source (e.g., light source 182 in FIG. 4) to be received at a sensor module (e.g., sensor module 180 in FIG. 4). However, recess portion 320 does not contact support surface 310, thereby preserving recess portion 320 as navigation surface that is free from mechanical wear against support surface 310 to maintain the desired optical features of recess portion 320 as a navigation surface. However, because the remaining portion of navigation surface 303 is still generally spherical, navigation surface 303 remains generally slidably rotatable relative to support surface 310. In one aspect, this embodiment omits guiding mechanism 330.

In another embodiment, navigation surface 303 does not include recess portion 320 but support surface 310 comprises a recess portion 306 (indicated by dashed lines at 208). In this arrangement, navigation surface 303 is still substantially spherical without interruption but support surface 310 includes a recess portion to prevent wear of navigation surface 303 to maintain high optical features of navigation surface 303. However, because the remaining portion of support surface 310 is still in slidable contact with navigation surface 303 of navigation member, the relationship of slidable rotation of navigation surface 303 relative to support surface 310 is maintained. In one aspect, this embodiment omits guiding mechanism 330.

In another embodiment, pointing device 300 further comprises a guiding mechanism 330. As shown in FIG. 8, guiding mechanism 330 in positioned between navigation member 302 and base 304 to maintain navigation surface 303 of navigation member 302 to be in close proximity to, but spaced apart from support surface 310 of base 304. Guiding mechanism 330 enables slidable rotation of navigation surface 303 relative to a support surface 332. This arrangement prevents wear of navigation surface 303 and/or wear of support surface 310 because navigation surface 303 is not in direct contact with support surface 310. In one aspect, this embodiment omits recess portion 320 of navigation member 302 and omits recess portion 306 of base 304.

In another embodiment, guiding mechanism 330 further comprises a spring component to enable pressure sensing associated with a downward pressure of navigation surface 303 of navigation member 302 relative to support surface 310 of base 304. In one aspect, guiding mechanism 330 maintains navigation surface 303 in a generally spaced relationship relative to support surface 310 of base 304. However, the spring component of guiding mechanism 330 enables an external downward pressure (such as external force F) to move navigation surface 303 closer toward support surface 310 of base 304. The reduction in spacing between navigation surface 303 and support surface 310 is detected as an altered optical signal (e.g. an optical signal with increased intensity) that is sensed via a sensor array (such as sensor array 32 in FIG. 1). In one aspect, the spring component comprises a two stage spring component in which actuation of a first stage of the spring component corresponds to a “wake-up” signal to actuate the tracking of the cursor on the display or tracking of control inputs. A second stage of the spring component level is used to implement the “click” function that is generally associated with a mouse-type pointing device or associated with selection of a function via other types of user control inputs.

In one embodiment, pointing device 300 comprises substantially the same features and attributes as pointing devices 10, 150 as previously described in association with FIGS. 1-6, except for: (1) further comprising recess portion 320 in navigation member 302; (2) further comprising recess portion 306 in support surface 310 of base 304; and/or (3) further comprising guiding mechanism 330.

FIG. 9 is a diagram illustrating a partial view of a pointing device 350, according to an embodiment of the invention. As shown in FIG. 9, pointing device 350 comprises navigation member 352 and support structure 354. Navigation member 352 comprises first generally spherical surface 353. Support structure 354 comprises first generally spherical support surface 360, that has a generally concave shape, to reciprocate generally convex first surface 353 of navigation member 352.

In one embodiment, navigation member 352 of pointing device 350 comprises a navigation surface 353 having more than one surface pattern. In one embodiment, navigation member 352 has two different surface patterns. In another embodiment, navigation member 352 has three or more different surface patterns. Each surface pattern (370-374) defines a pattern that produces a different optical effect or image at a sensor module (e.g., sensor module 182).

In one aspect, each pattern is a contrast pattern for enabling generating movement information without image-based processing of reflected images of a navigation surface.

In one aspect, each of these patterns is also positioned at different locations on navigation surface 353, so that as a different pattern of light is reflected to the sensor module, additional information regarding the relative movement of navigation member 352 is provided. For example, light reflected from third pattern 374 would indicate that navigation member 352 has traveled substantially the entire range of motion along support surface 360, while light reflected from first pattern 372 would indicate that navigation member has traveled only small distance, near its center at-rest position. Moreover, in one aspect, when light reflected from navigation surface 353 is at a transition between adjacent patterns (e.g., pattern 372 and pattern 374), this change in the pattern of reflected light is used to signal a change in the overall magnitude of movement. The different surface patterns (370-374) can also be used to help detect a direction of movement and/or a change in a direction of movement of navigation surface 353.

In one embodiment, pointing device 350 comprises substantially the same features and attributes as pointing devices 10, 150 as previously described in association with FIGS. 1-6, except for navigation surface 353 of navigation member further comprising first surface pattern 370, second surface pattern 372, and/or third surface pattern 374.

In one aspect, a sensor (e.g., sensor array 32 in FIG. 1) detects a change between two adjacent surface patterns during slidable rotation of navigation surface 353 relative to support surface 310 and signals a controller (such as optical navigation circuit 60) to change a navigation mode associated with pointing device 300. For example, when a user rotates third surface pattern 374 into view of the sensor (e.g., sensor array 32), this position of navigation surface 353 indicates the desire for a large movement of a screen pointer. Based on this indicated desire, the controller or a software algorithm switches from a linear input mode (commonly referred to as a mouse mode) to a cursor velocity input mode (commonly understood as joystick mode in which a cursor velocity is proportional to displacement of the pointing device such as the joystick). One approach of implementing a mode change for a pointing device is disclosed in a commonly assigned pending patent application titled MODE MANAGER FOR A POINTING DEVICE, having Ser. No. 11/121,813, filed May 4, 2005.

Embodiments of the invention are directed to optical navigation devices, such as an input device including a titling disc that has a generally spherical navigation surface. In one embodiment, a tilting movement of a navigation member causes slidable rotation of an illuminated generally spherical navigation surface. Optical effects (e.g., light reflected off the navigation surface) generated as the navigation surface is moved relative to a support surface are detected at a sensor module to generate movement information associated with user control inputs.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A user control input device comprising:
a navigation member including a substantially spherical first portion and a generally disc-shaped second portion, the first portion extending outwardly from the second portion;
a light source configured to illuminate the first portion;
a sensor module configured to detect movement of the illuminated first portion to generate movement information for the screen pointer; and
a support structure including a support surface configured to enable rotational movement of the first portion relative to the sensor module in response to tilting movement of the second portion of the navigation member.

2. The user control input device of claim 1 wherein the support structure comprises:
a generally transparent base interposed between the sensor module and the navigation member, and the support surface including a first recess portion configured to laterally constrain and vertically support the first portion of the navigation member, wherein the support surface includes an at least partially spherical surface to enable slidable rotation of the first portion of the navigation member relative to the first recess portion of the base; and
a restraining mechanism extending from the second portion of the navigation member and configured to vertically constrain the first portion of the navigation member within the first recess portion of the base and to enable the tilting movement of the second portion of the navigation member.

3. The user control input device of claim 2 wherein substantially the entire first portion of the navigation member is in slidable contact with the support surface of the body.

4. The user control input device of claim 2 wherein the base comprises a generally annular shaped second recess portion arranged concentrically relative to the first recess portion with a generally annular-shaped ridge portion interposed between the first recess portion and the second recess portion.

5. The user control input device of claim 2 wherein the restraining mechanism comprises a resilient member coupled to and extending outwardly from an outer edge of the second portion of the navigation member, the resilient member defining a generally disc-shaped member including an outer edge; and
wherein the base comprises a generally disc shaped member including an outer edge extending outwardly from the second recess portion and coupled to the outer edge of the resilient member, the outer edge sized and shaped to generally maintain the resilient member in spaced relation above a surface of the base.

6. The user control input device of claim 5 wherein the resilient member comprises an elastomeric material to enable biasing the second portion of the navigation member to return to a generally horizontal position from a generally non-horizontal position achieved via the tilting movement of the second portion of the navigation member.

7. The user control input device of claim 5 wherein the resilient member and the base form an enclosure defining an interior chamber that excludes ambient conditions from the first portion of the navigation member.

8. The user control input device of claim 5 and further comprising:
a ring secured relative to the outer edge of the second portion of the navigation member and secured relative to the resilient member, the ring having a diameter to be positioned generally vertically over the second recess portion of the base.

9. The user control input device of claim 1 wherein the input device comprises a
a substrate for supporting the sensor module, the light source, and the support structure, wherein the second portion of the navigation member is generally parallel to the base when in an at-rest non-tilted position.

10. The user control input device of claim 1 and further comprising:
at least one pressure switch secured relative to the substrate and positioned for activation upon a downward pressing action of the navigation member that exceeds a predetermined force threshold.

11. The user control input device of claim 1 wherein the general disc shape of the second portion of the navigation member comprises a generally flat portion and wherein the substantially spherical shape of the first portion of the navigation member comprises a generally hemi spherically shaped member disposed on a central portion of the second portion.

12. The user control input device of claim 1 comprising a pointing device wherein the sensor module comprises a sensor circuit for causing a screen pointer to move on a display in response to movement of the navigation member in a field of motion defined by the support structure, the magnitude and direction of motion of the screen pointer being determined by the magnitude and direction of motion of the navigation member in the field of motion.

13. The user control input device of claim 1 and further comprising a portable electronic device, the portable electronic device comprising at least one member of a group comprising a phone, a portable audio device, a camera, a personal digital assistant, a universal remote, a handheld computer, or a handheld global positioning satellite device.

14. An apparatus for capturing user control inputs, the apparatus comprising:
a light source;
a navigation mechanism including:
a sliding mechanism comprising two opposed partially spherical portions including a first portion and a second portion, the first portion positioned for slidable rotation relative to the second portion and being at least partially reflective for illumination by the light source, the second portion being at least partially transparent to enable transmission of light reflected from the first portion through the second portion to generate optical effects associated with the illuminated first portion; and
a tilting mechanism sized and shaped to cause the slidable rotation of the first portion and the second portion of the sliding mechanism relative to each other; and
a navigation sensor for determining movement information, based on digital representations of generated optical effects from the illuminated first portion, that is indicative of relative motion between the first portion and the second portion of the first mechanism of the navigation mechanism.

15. The apparatus of claim 14, wherein the first portion of the sliding mechanism comprises a generally convex member and the second portion of the sliding mechanism comprises a generally concave member.

16. The apparatus of claim 14, wherein the tilting mechanism comprises a generally disc-shaped member having a central region from which the first portion of the sliding mechanism protrudes outwardly to form the first portion as a generally hemispherical member.

17. A method of generating movement data with an optical input device, the method comprising:
illuminating, via a light source, an at least partially spherical navigation surface of a tilting disc;
guiding the at least partially spherical portion of the tilting disc in slidable rotational movement relative to a support structure in response to tilting movement of a generally non-spherical portion of the titling disc;
sensing optical changes, transmitted through the support structure, at a sensor array based on movement of the illuminated spherical portion of the tilting disc relative to the sensor array; and
generating movement data based on the sensed optical changes to capture user control inputs.

18. The method of claim 17, and further comprising:
interposing a resilient member between the generally horizontal portion of the tilting disc and the support structure to bias the generally non-spherical portion to return to a generally horizontal position after a tilting movement of the generally non-spherical portion.

19. The method of claim 18, wherein guiding the at least partially spherical portion comprises:
arranging the resilient member to constrain the at least partially spherical portion of the tilting disc to remain in sliding contact with the support structure during tilting movements of the tilting disc and to prevent generally lateral movement of the tilt disc relative to the support structure.

20. The method of claim 18 and further comprising:
arranging the light source relative to the tilting disc to backlight the resilient member.
